(19) United States
(12) Patent Application Publication
(10) Pub. No.: US 2025/0307799 A1
(43) Pub. Date: Oct. 2, 2025

(54) EXTEMPORANEOUSLY CONCEALED NFT PROMOTION PLACEHOLDERS QR CODE BANKING MARKETING TECHNOLOGY

(71) Applicant: Bank of America Corporation, Charlotte, NC (US)

(72) Inventors: Shailendra Singh, Maharashtra (IN); Saurabh Gupta, New Delhi (IN)

(21) Appl. No.: 18/619,495

(22) Filed: Mar. 28, 2024

(51) Int. Cl. G06Q 20/32; G06Q 20/40

(52) U.S. Cl. CPC G06Q 20/3276; G06Q 20/4016; G06Q 2220/00

(57) ABSTRACT

A method for inserting a plurality of promotion placeholders into a quick response (“QR”) code. The method may include generating an inactive QR code, using a first device. The inactive code may include an algorithmic code and the promotion placeholders. The method may scan the inactive QR code using a second device. The method may send the scan to a QR analyzer. The QR analyzer may interpret the algorithmic code to identify a plurality of non-fungible tokens (“NFTs”) for filling the promotion placeholders. The method may generate the NFTs and complete the inactive QR code to form a complete QR code. The methods may include filling the promotion placeholders with the NFTs and interpreting the complete QR code. Interpreting the complete QR code may include executing a transaction between the first device and the second device. The methods may include adjusting the transaction based on information interpreted from the NFTs.

### FIELD OF TECHNOLOGY

Aspects of the disclosure relate to preventing fraudulent QR-code schemes.

### BACKGROUND OF THE DISCLOSURE

Conventional payment instruments are shifting to online payment technologies such as for example the Unified Payments Interface developed by National Payments Corporation of India (“NPCI”). This is but one instance of a real-time payment system. The exemplary interface facilitates inter-bank peer-to-peer (“P2P”) and person-to-merchant (“P2M”) transactions. It can be used on mobile devices to instantly transfer funds between two bank accounts.

Not surprisingly, QR code fraud is emerging as a significant source of financial fraud. Fraudsters are circulating fraudulent QR codes to misdirect payment(s) into fraudster's account(s). Alternatively, they are using fake QRs to install malware into a user's mobile device and/or misappropriate financial institution (FI) or other critical payment information.

Conventionally, all the current mechanisms to deal with such scenarios are reactive approaches and not proactive approaches. A payment technology user is informed about the fraudulent payment or loss of funds when the transaction has already happened. In such approaches, there is no way to prevent fraud prior to the occurrence thereof.

QR code transfer applications currently lack customer engagement with their financial institution. The lack of personalized and targeted promotions or discounts affects the application's ability to showcase relevant offers resulting in missed opportunities to drive customer acquisition and increase transaction frequency.

It would be desirable to provide a technology which enables an FI to proactively identify a fake QR code in the middle of the transaction, prior to actually consummating the money transfer or information transfer. It would be further desirable to develop a QR code transfer application with the ability to interact with the customer to promote customer engagement.

### SUMMARY OF THE DISCLOSURE

A method for increasing the security of quick response (“QR”) code processing is provided. The method may include generating, using a first device, an inactive or at least partially inactive QR code. The inactive QR code may include an algorithmic code. The algorithmic code preferably encodes locations of a plurality of promotion placeholders. The method may include scanning, using a second device, the inactive QR code, and then sending the inactive QR code to a QR analyzer system. The QR analyzer system may determine a location of each of the plurality of promotion placeholders. The QR analyzer system may generate, using the algorithmic code, a plurality of non-fungible tokens (“NFTs”) for filling the plurality of promotion placeholders. The method may then include inserting the plurality of NFTs into the inactive QR code to form a complete QR code. The completing may include filling the plurality of promotion placeholders with the plurality of NFTs. Once the QR code is completed, the method may include interpreting the complete QR code to execute a transaction between the first device and the second device. The method may include adjusting the transaction based on information interpreted from the plurality of NFTs.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative system in accordance with principles of the disclosure;

FIG. 2 shows an illustrative system in accordance with principles of the disclosure;

FIG. 3 shows a schematic diagram of a secure QR code generation apparatus in accordance with principles of the disclosure;

FIG. 4 shows a schematic diagram of a QR code with promotion placeholders in accordance with principles of the disclosure;

FIG. 5 shows a schematic diagram of a QR code validation procedure in accordance with principles of the disclosure;

FIG. 6 shows another schematic diagram of a secure QR code generation apparatus in accordance with principles of the disclosure;

FIG. 7 shows an illustrative flow diagram in accordance with principles of the disclosure; and

FIG. 8 shows an illustrative architecture diagram in accordance with principles of the disclosure.

### DETAILED DESCRIPTION OF THE DISCLOSURE

A technology according to the disclosure can significantly mitigate attempts to derail and defraud the QR payments industry. Such a technology could significantly improve the fidelity of the QR payments industry.

Embodiments of the invention preferably create one or more extemporaneously concealed NFT promotion placeholder(s) in a QR code for use with code fraud prevention technology. These placeholders preferably enable the QR codes with substantially everchanging promotion placeholders. It should be noted that, while the disclosure herein is directed to QR codes, the scope of the invention should be understood to cover any machine-readable labels such as, for example, bar codes or other suitable machine-readable labels.

Any mobile, or other, device will not be able to scan these QR codes absent, or independent of, some of these hidden placeholders. These placeholders are filled with valid NFTs at run time—i.e., at the time the QR code is ready to be fully executed, having been fetched from the relevant FI. Once some or all of the placeholders are filled, then, and preferably only then, the QR code is considered fully operational—i.e., complete and fully scannable—and will be viable to fetch account and/or customer information. The NFTs that fill the promotion placeholders may include information that affects a transaction. The information may relate to discounts, promotions or offers provided by the relevant FI. The information may display a targeted advertisement or marketing promotion on the mobile device. The displayed advertisement may be selected based on the customer's information or account.

The aforementioned technology preferably generates and/or maintains the QR codes in an unreadable and incomplete state pending the retrieval and completion of the promotion placeholders.

Preferably, the FI may designate an algorithm to be used in interpreting the inactive QR code. There may be a plurality of algorithms. Each algorithm may interpret the inactive QR code in a different manner. There may be only one correct way to interpret the inactive QR code in order to execute the transaction.

Preferably, the FI designates which hidden placeholders are to be filled, and the positions in which they may be filled. This information may be based on a database maintained by the FI.

For example, if, with the last transaction involving the QR code, placeholders 1 and 9 were filled, then, with the next transaction, placeholders 1 and 9 will not be filled and the FI will pick placeholders 3 and 4 to be filled.

Which ones and how many placeholders to be filled with which NFTs, may, in certain embodiments, be governed by the algorithm stored in the QR. The placeholders may preferably be interpreted solely by the FI. The NFTs may include information related to a past transaction. The information may be a picture of a legacy complete QR code used in the past transaction. The NFTs may include promotional content.

Also, this technology preferably decisions with which past transaction NFT to fill the QR code. In preferred embodiments, the FI does not repeat the NFT used to fill the QR code. Even if a fraudster compromises the code and tries to reuse the placeholder information, the fraudster may not be able to complete the QR code because the next set of placeholders will be different from the prior set of placeholders. In certain embodiments, only the FI may know which NFTs need to be placed. Any change in the pattern or information preferably flags the QR as fake or at least incomplete.

NFTs generated to fill the promotion placeholders may have additional data contained therein. The additional data, when interpreted by a QR code application, may display a targeted advertisement to the customer. The additional data may automatically include discounts for the transaction executed.

For example, after reading the complete QR code the transaction may be adjusted to reflect a 5% discount applied toward the transaction. The discount may be given by the FI. The discount may be given by the merchant. The customer may not be aware of the discount. The customer may be informed of the discount during a promotional video displayed on the customer's device during the execution of the transaction.

The merchant may communicate with the FI through a QR analyzer system to generate the inactive QR code. The FI may incorporate the algorithm, the location of the placeholders and the past transactions to be turned into an NFT to be placed into the generated inactive QR code.

A method for inserting a plurality of promotion placeholders into a quick response (“QR”) code is provided. The method may include generating, using a first device, an inactive or partially inactive QR code. The QR code may be inactive because it is incomplete. The inactive QR code may include an algorithmic code and a plurality of dynamic placeholders. The first device may belong to a first user. The first user may be a merchant. The first device may be a merchant point of sale (“MPOS”) terminal. The first device may be a smartphone or any other smart device capable of reading QR codes. The first user may be a customer with an FI.

The first device may generate the inactive QR code based on data received from a QR analyzer system. The QR analyzer system may be maintained by the FI. The QR analyzer system may include one or more of the following: a QR generation module, a QR analyzer module, a QR fraud prevention module, an NFT generator, a smart contract module, a QR-NFT orchestration module and/or an FI integration module.

The data may include a selection of an algorithm, an indication of a location within the inactive QR code of the plurality of placeholders and an indication of which past transactions to utilize in generating NFTs to fill the placeholders.

The algorithm may be selected from a plurality of algorithms. Each algorithm may interpret the inactive QR code in a different manner. For example, using algorithm 1 to interpret the inactive QR code may define placing the promotional placeholders in location 1 and 9, while using algorithm 2 to interpret the inactive QR code may define placing the promotional placeholders in location 3 and 4. The FI integration module may communicate to the QR generation module which algorithm to embed in the inactive QR code. The QR generation module may embed the selection when generating the inactive QR code.

The location, within the inactive QR code, of the plurality of placeholders may be embedded in the inactive QR code. The FI integration module may communicate to the QR generation module the locations of the placeholders to embed in the inactive QR code. The QR generation module may embed the locations when generating the inactive QR code. The location may only be determined by using the correct algorithm.

The past transactions utilized in generating the NFTs to fill the placeholders may be embedded in the inactive QR code. The promotion placeholders may be replaced once scanned by a second device. The promotion placeholders may be empty locations within the inactive QR code. The promotion placeholders may be in incorrectly filled locations. The inactive QR code may be uninterpretable without replacing or filling the locations. The locations may be replaced or filled with NFTs. The past transactions may be utilized in generating the NFTs to replace or fill the locations.

The data may be embedded into the inactive QR code through an algorithmic code. The QR generation module may generate the inactive QR code to include the algorithmic code and the plurality of promotion placeholders in the location designated by the algorithmic code.

The first device may receive the data from the QR analyzer system via an internet connection. The first device may display the generated inactive QR code.

The methods may include scanning the displayed inactive QR code by a second device. The second device may be a smartphone or any other device capable of reading QR codes. The second device may belong to a second user. The second user may be a customer with the FI.

The second device may be unable to fully interpret the inactive QR code. The second device may be in communication with the QR analyzer system via an internet connection. The second device may send the inactive QR code to the QR analyzer system via the internet connection. The QR analyzer system may analyze the inactive QR code.

The QR analyzer module may determine the selected algorithm from the inactive QR code. The QR analyzer system may utilize the algorithm to determine the location of the plurality of promotion placeholders and the past transactions to utilize in generating NFTs to fill the promotion placeholders.

Once the past transactions are determined, the NFTs may be generated. The NFTs may be generated by the NFT generator. The NFTs may include information relating to the past transactions. The NFTs may include an image of a legacy complete QR code. The legacy complete QR code may be a complete QR code from a past transaction with the first device. The legacy complete QR code may be a complete QR code from a past transaction with the first user. The legacy complete QR code may be a complete QR code from a past transaction with the inactive QR code. The NFT may include embedded information that may adjust the transaction. The NFT may include embedded information that may display a targeted advertisement to whomever scans and interprets the inactive QR code. The embedded information may be determined by the FI integration module. The embedded information may be generated by the NFT generator.

The FI integration module may select which past transactions to convert into NFTs. The selection may be communicated to the QR generation module for integration into the inactive QR code.

The methods may include replacing or inserting the generated NFTs into the plurality of promotion placeholders to form a complete QR code. The QR-NFT orchestration module may insert the NFTs into the inactive QR code in a manner in which the QR code will be readable.

The QR code scanned by the second device may be sent to the QR fraud prevention module via the internet connection. The QR fraud prevention module may analyze the scanned QR code to identify whether the scanned QR code is fraudulent. The scanned QR code may be identified as a complete QR code. The scanned QR code may be identified as an inactive QR code. The QR fraud prevention module may determine whether the scanned QR code is fraudulent. The QR fraud prevention module may compare the completed QR code with the embedded algorithmic code present in the inactive QR code. The QR fraud prevention module may analyze a scanned inactive QR code to ensure the algorithmic code is suitable for the scanned inactive QR code. Any deviations may flag the scanned QR code as fraudulent. A flagged QR code may not be filled or replaced with NFTs. A flagged QR code may not execute a transaction. A flagged QR code may be uploaded to a fraudulent QR code database.

The methods may include sending the complete QR code to the second device. The second device may interpret the complete QR code. Successful interpretation of the complete QR code may execute a transaction. The transaction may include transferring funds from a user of the first device to a user of the second device. The transaction may include a transfer of information from the first device to the second device. The NFTs may include embedded information, that when interpreted by the second device, may adjust the transaction. The adjustment may include a discount applied to a monetary transaction. The adjustment may include an offer applied to a customer's account. The NFTs may include embedded information, that when interpreted by the second device, may display content on the second device. The content may be tailored to the customer's account.

The following figures and associated written specifications set forth the invention in additional detail to the foregoing.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

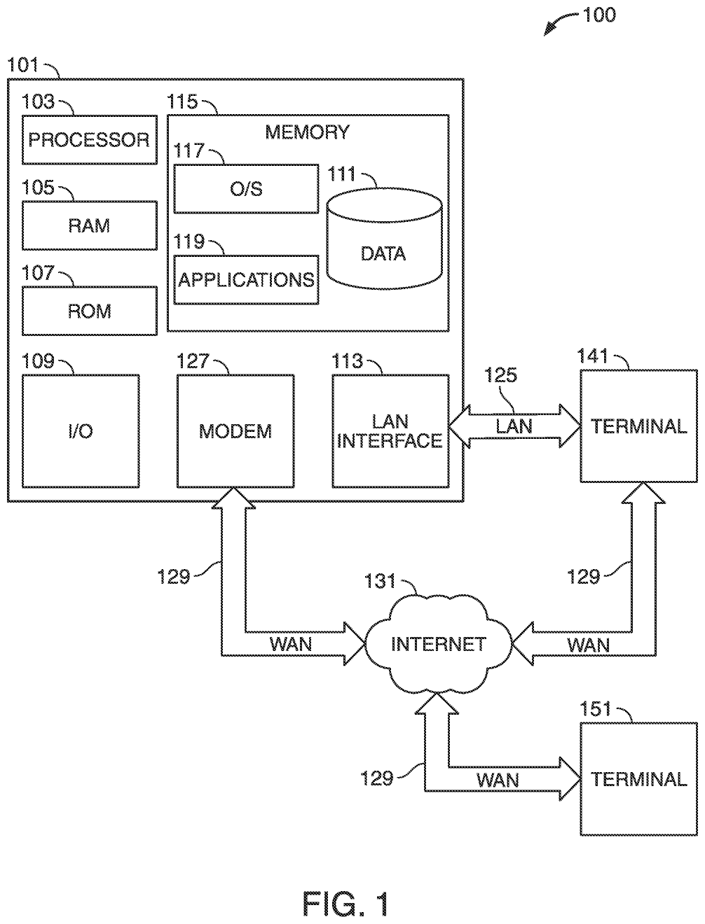

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may have a processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. The processor 103 may also execute all software running on the computer. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). The computer 101 may execute the instructions embodied by the application program(s) 119 to perform various functions.

Application program(s) 119 may utilize the computer-executable instructions executed by a processor. Generally, programs include routines, programs, objects, components, data structures, etc., that perform particular tasks or implement particular abstract data types. A computing system may be operational with distributed computing environments where tasks are performed by remote processing devices that are linked through a communications network. In a distributed computing environment, a program may be located in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

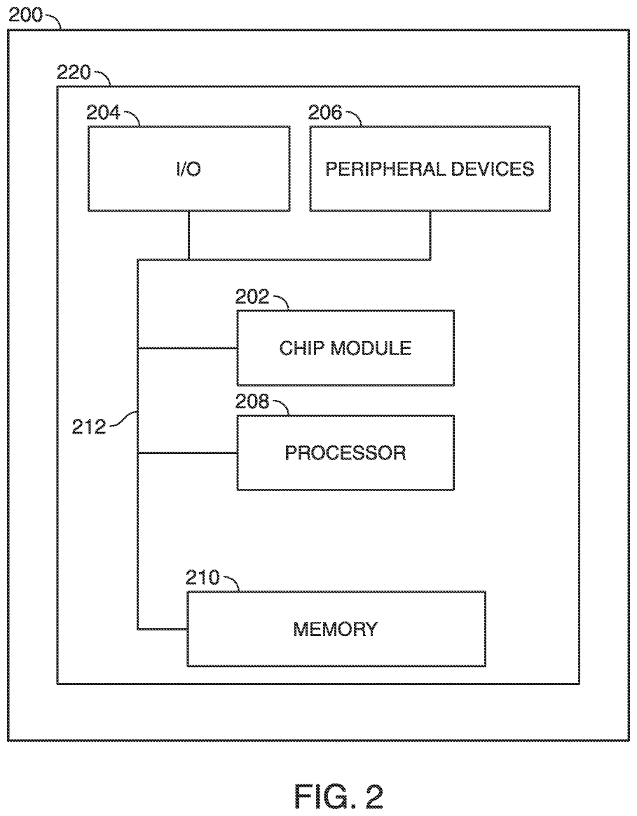

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119, signals, and/or any other suitable information or data structures.

Components 202, 204, 206, 208 and 210 may be coupled together by a system bus or other interconnections 212 and may be present on one or more circuit boards such as circuit board 220. In some embodiments, the components may be integrated into a single chip. The chip may be silicon-based.

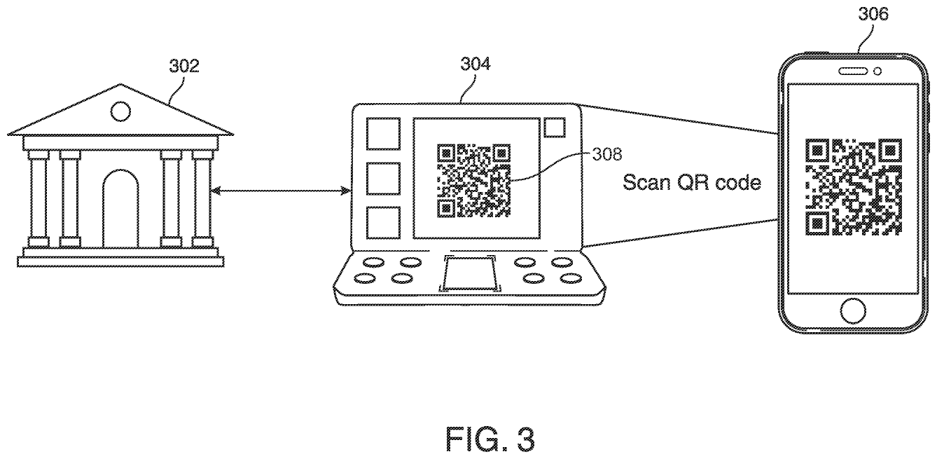

FIG. 3 shows a schematic diagram of a secure QR code generation apparatus in accordance with principles of the disclosure. FI 302 is shown. QR-code generating device 304 is shown. Mobile device 306 is shown. Mobile device 306 may scan QR code 308 generated by QR-code generating device 304. In one embodiment, a method according to the embodiments preferably ensures that QR-code generating device 304 is not used for tampering, in some way, with generated QR code 308.

In some embodiments, meta data properties of QR-code generating device 304 may confine QR-code generating device 304 to generating QR-codes that include promotion placeholders, as set forth herein.

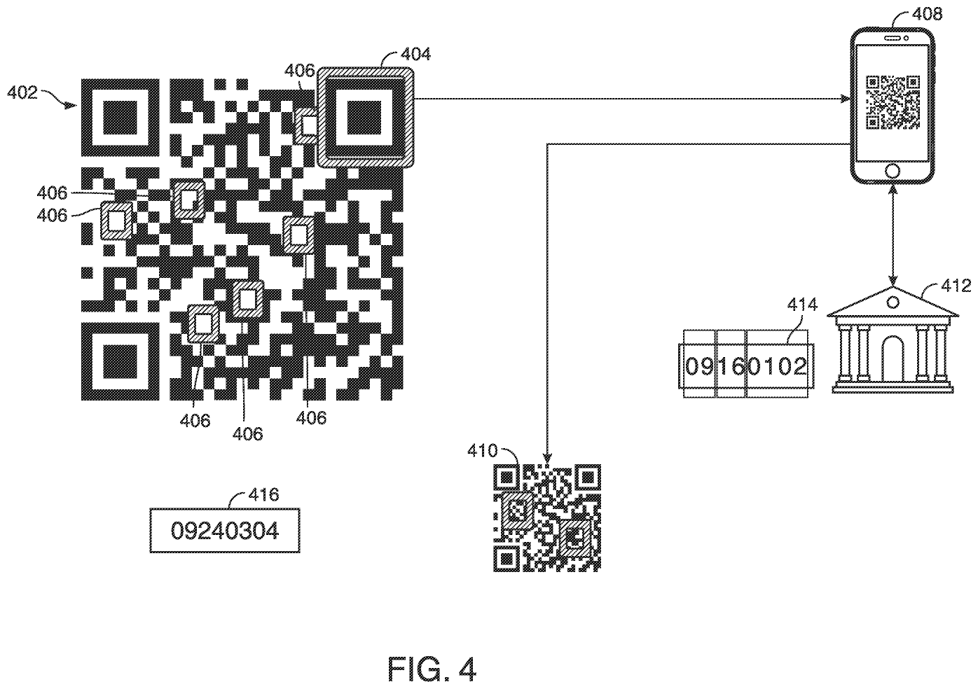

FIG. 4 shows a schematic diagram of QR code 402 with promotion placeholders 406 in accordance with principles of the disclosure. QR code 402 may be an inactive QR code—i.e., inactive to the extent that it cannot execute instructions stored therein absent replacing or filling promotion placeholders 406. An algorithm field (such as field 404 or other suitable field) preferably informs FI 412, via mobile scanning device 408, which promotion placeholders 406 within QR code 402 are to be filled.

Algorithm 414 shows a representative of an exemplary algorithm. Algorithm 414 may include “09” which indicates that algorithm No. 9 is to be used to select the promotion placeholders for QR code 402. Algorithm 414 may include “16” which indicates that fields 1 and 6 within QR code 402 are to be replaced or filled. Algorithm 414 may include “0102” which indicates that the last and second to last transactions associated with the scanned QR code are selected to be mined to retrieve the information necessary to fill in promotion placeholders 406.

Complete QR code 410 is shown. Promotion placeholders 406 have been replaced or filled with the missing information to create complete QR code 410.

Second exemplary algorithm 416 is shown. Second exemplary algorithm 416 may be associated with a different QR code.

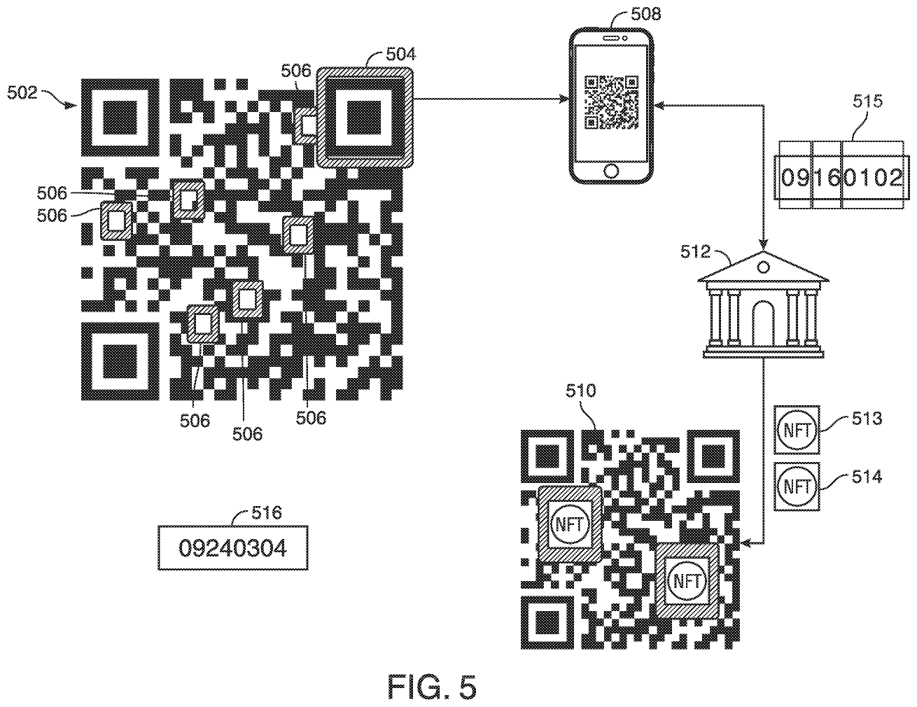

FIG. 5 shows a schematic diagram of a QR code validation procedure in accordance with principles of the disclosure. It should be noted that in FIG. 5, elements 502, 504, 506, 508, 512, 515 and 516 substantially correspond to the elements 402, 404, 406, 408, 412, 414 and 416 in FIG. 4.

One significant difference between FIG. 4 and FIG. 5 is shown at NFTs 513 and 514. In the embodiment shown in FIG. 5, NFTs 513 and 514 have been leveraged to fill the promotion placeholders, as shown in QR code 510. Preferably, the technology according to the embodiments fetch legacy transaction NFTs, or other suitable NFTs, in a dynamic sense to replace or fill the promotion placeholders in order to complete QR code 510.

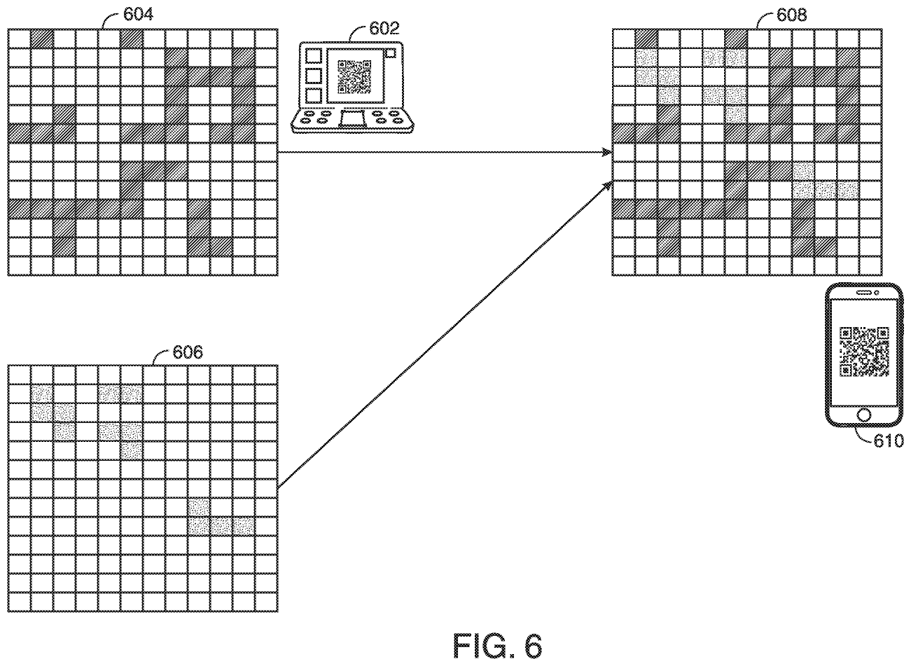

FIG. 6 shows another schematic diagram of a secure QR code generating device in accordance with principles of the disclosure. QR code generating device 602 is shown. QR code generating device 602 may be configured to generate inactive QR code 604 with dynamic placeholders—i.e., placeholders that are configured to shift from one region of inactive QR code 604 to a different region of inactive QR code 604 for preferably each and every scan event.

Element 606 shows, schematically, minting NFTs for use with algorithmically generated promotion placeholder QR patterns. Specifically, the NFTs that are shown as minted in 606 may be combined with inactive QR code 604.

Complete QR code 608 is shown. Complete QR code 608 may preferably be scanned by QR code scanning device 610 to obtain desired results—e.g., whether to retrieve certain information or to guide a user to a pre-determined URL.

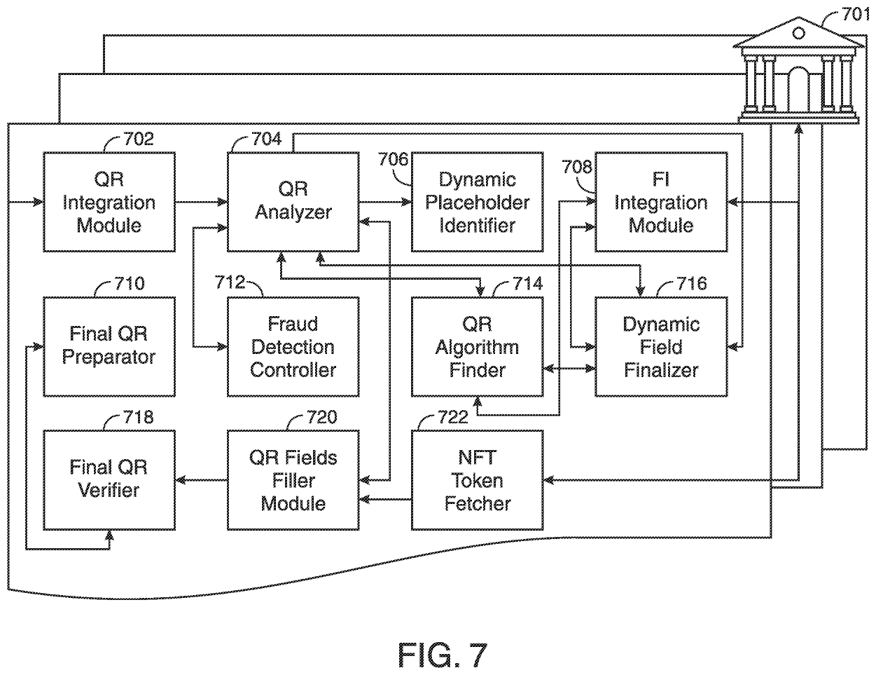

FIG. 7 shows an illustrative flow diagram in accordance with principles of the disclosure. FI 701 is shown. QR integration module 702 is shown. QR integration module 702 may serve to integrate the QR code, and the associated uptake of the QR code, with the scanning device. QR code analyzer 704 may be coupled to QR integration module 702. QR code analyzer 704 may read and interpret the QR code. This preferably represents the very first analysis of the QR code which has been scanned. In some embodiments, QR code analyzer 704 may be used to immediately transfer the scanned QR code, preferably prior to analysis, to a secure FI backend, via FI integration module 708, thereby preventing any uptake of information at the scanner and sending the QR for a safe analysis at the FI backend, preferably isolated from the mainstream portion(s) of the scanner. In so doing, the portions of the scanner that can be attacked are preferably protected from the portion(s) of the scanner that are used to initiate verification the analysis.

Dynamic placeholder identifier 706 may identify the placeholder locations, preferably using a proprietary and secure algorithm, within the inactive QR code. FI integration module 708 may be responsible for communicating with FI 701 in order to help retrieve the information associated with the placeholders. Such information may include deciphering the algorithm that is used to retrieve the correct placeholders.

Dynamic field finalizer 716 finalizes, based on the algorithm, which fields are to be filled with the imported NFTs. QR algorithm finder 714 may identify the algorithm at FI 701.

Fraud detection controller 712 may receive the scanned QR code. Fraud detection controller 712 may identify whether some physical tampering has been done with the scanned QR code, or other sort of tampering has been done, at least because one, more than one or all of the dynamic placeholders are absent or the scanned QR code has changed its structures from the last time. Such structures may include location of the dynamic placeholders within the scanned QR-code.

In essence, fraud detection controller 712 receives and explores any deviation in the QR code from past scans of the same code, or, alternatively, scans of co-located, but different, QR codes and preferably reports same.

QR fields filler module 720 may replace or fill the placeholders, determined by dynamic filed finalizer 716, with NFTs. The NFTs may come from NFT token fetcher 722. QR fields filler module 720 may replace or fill the placeholders in a manner in which the inactive QR code becomes complete and is able to be interpreted by a QR code scanning device.

NFT token fetcher 722 may retrieve NFTs from FI 701. The NFTs may be created from previous transactions, or from other data, at FI 701. The retrieved NFTs may be used, as set forth herein, to replace or fill the placeholders that have been determined according to QR analyzer 704. Final QR verifier 718 may verify that the complete QR code is readable. Final QR preparator 710 may finalize the complete QR code and send it back to the scanning device.

It should be noted that the inactive QR code is preferably prevented from being fully processed by the scanning device and within the central server prior to full verification. That is to say that one or more applications may be hosted on the scanning device and within the central server that prevents QR code processing prior to resolution and verification of the QR code by some or preferably all of the full architecture set forth in FIG. 7.

Thereafter, the QR code may be processed by one or more processors as performed in line with conventional QR code protocols.

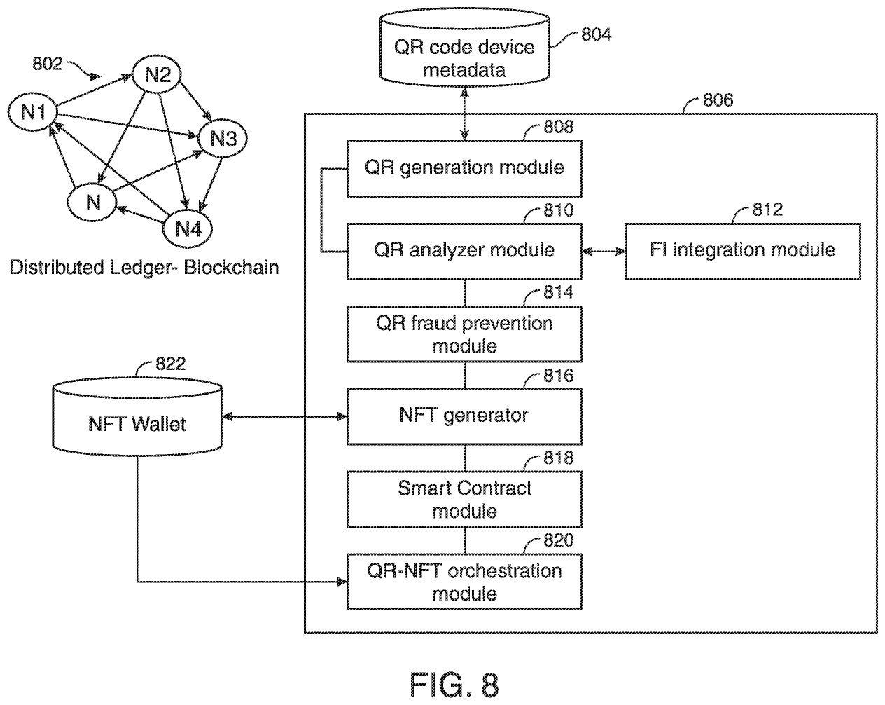

FIG. 8 shows an illustrative architecture diagram in accordance with principles of the disclosure. A schematic diagram of distributed ledger-blockchain 802 is shown. QR code device metadata database 804 is shown. QR code device metadata database 804 may interact with system 806 in such a way as to provide QR code information (including QR code metadata) from a QR code scanning device. The metadata may include data reflective of the QR code scanning device as well as the QR code itself. In certain algorithms according to the disclosure, data reflective of the QR code scanning device may form part of the verification algorithm—i.e., the scanning device information may be used as a part of the algorithm.

Also shown in FIG. 8 is QR generation module 808 which may be involved with the formation of QR codes together with the placeholders. QR generation module 808 may be in communication with QR analyzer module 810. QR analyzer module may be in communication with FI integration module 812. QR analyzer module 810 may also be in communication with QR fraud prevention module 814 according to the embodiments set forth herein.

NFT generator 816 may be in communication with NFT wallet 822. NFT wallet 822 may be external to system 806. NFT generator 816 may be in communication with smart contract module 818. NFT wallet 822 may be used to store NFTs and, thereafter, to retrieve NFTs to fill the placeholders. QR-NFT orchestration module 820 may enable methods according to the embodiments to adding existing NFTs to the NFT placeholders to provide a complete QR code.

Thus, methods and apparatus for providing EXTEMPORANEOUSLY CONCEALED NFT PROMOTION PLACEHOLDERS QR CODE BANKING MARKETING TECHNOLOGY are provided. Persons skilled in the art will appreciate that the present invention can be practiced by other than the described embodiments, which are presented for purposes of illustration rather than of limitation, and that the present invention is limited only by the claims that follow.

What is claimed is:

1. A method for generating a plurality of promotion placeholders in a quick response (“QR”) code, the method comprising:
generating, using a first device, an inactive QR code comprising:
an algorithmic code; and
the plurality of promotion placeholders;
scanning, using a second device, the inactive QR code;
sending, by the second device, the inactive QR code to a QR analyzer system;
determining, by the QR analyzer system using the algorithmic code, a location of each of the plurality of promotion placeholders;
generating, by the QR analyzer system using the algorithmic code, a plurality of non-fungible tokens (“NFTs”) for replacing the plurality of promotion placeholders;
inserting the plurality of NFTs into the plurality of promotion placeholders to form a complete QR code;
interpreting, by the second device, the complete QR code to execute a transaction between a user of the first device and a user of the second device; and
adjusting the transaction based on information interpreted from the plurality of NFTs.

2. The method of claim 1 wherein the first and second devices communicate with the QR analyzer system via an internet connection.

3. The method of claim 1 wherein the inactive QR code can only be interpreted by inserting the plurality of NFTs.

4. The method of claim 1 wherein a number of the plurality of promotion placeholders corresponds to a number of the plurality of NFTs.

5. The method of claim 1 wherein the NFTs are generated based on one or more previous transactions involving a legacy complete QR code, the legacy complete QR code being based in part on at least a portion of the inactive QR code.

6. The method of claim 5 wherein the one or more previous transactions are determined based on the algorithmic code.

7. The method of claim 1 wherein the generating the inactive QR code is based on data received from the QR analyzer system.

8. The method of claim 7 wherein the data:
includes:
a selection of an algorithm;
an indication of which previous transactions of a plurality of previous transactions to utilize in generating the NFTs;
an indication of a location, within the QR code, of the plurality of placeholders; and
is used to generate the algorithmic code.

9. A system for generating a plurality of promotion placeholders into a quick response (“QR”) code, the system comprising:
a processor; and
a non-transitory computer readable medium storing instructions that when executed by the processor:
generate, using a first device, an inactive QR code comprising:
an algorithmic code; and
the plurality of promotion placeholders;
scan, using a second device, the inactive QR code;
send, by the second device, the inactive QR code to a QR analyzer system;
determine, by the QR analyzer system using the algorithmic code, a location of each of the plurality of promotion placeholders;
generate, by the QR analyzer system using the algorithmic code, a plurality of non-fungible tokens (“NFTs”) for replacing the plurality of promotion placeholders;
insert the plurality of NFTs into the plurality of promotion placeholders to form a complete QR code;
interpret, by the second device, the complete QR code to execute a transaction between the first device and the second device; and
adjust the transaction based on information interpreted from the plurality of NFTs.

10. The system of claim 9 wherein the first and second devices communicate with the QR analyzer system via an internet connection.

11. The system of claim 10 wherein the inactive QR code can only be interpreted by inserting the NFTs.

12. The system of claim 11 wherein a number of the plurality of promotion placeholders corresponds to a number of the plurality of NFTs.

13. The system of claim 9 wherein the NFTs are generated based on one or more previous transactions involving a legacy complete QR code, the legacy complete QR code being based in part on at least a portion of the inactive QR code.

14. The system of claim 13 wherein the one or more previous transactions are determined based on the algorithmic code.

15. The system of claim 9 wherein the inactive QR code is generated based on data received from the QR analyzer system.

16. The system of claim 15 wherein the data:
includes:
a selection of an algorithm;
an indication of which previous transactions of a plurality of previous transactions to utilize in generating the NFTs;
an indication of a location, within the QR code, of the plurality of placeholders; and
is used to generate the algorithmic code.

17. A method for generating a plurality of promotion placeholders in a quick response (“QR”) code, the method comprising:
generating, using a first device, an inactive QR code comprising:
an algorithmic code; and
the plurality of promotion placeholders;
scanning, using a second device, the inactive QR code;
sending, by the second device, the inactive QR code to a QR analyzer system;
determining, by the QR analyzer system using the algorithmic code, a location of each of the plurality of promotion placeholders;
generating, by the QR analyzer system using the algorithmic code, a plurality of non-fungible tokens (“NFTs”) for replacing the plurality of promotion placeholders;
inserting the plurality of NFTs into the plurality of promotion placeholders to form a complete QR code;
interpreting, by the second device, the complete QR code to execute a transaction between a user of the first device and a user of the second device; and
adjusting the transaction based on information interpreted from the plurality of NFTs;
wherein:
the first and second devices communicate with the QR analyzer system via an internet connection; and
the inactive QR code is generated based on data received from the QR analyzer system.

18. The method of claim 17 wherein the inactive QR code can only be interpreted by inserting the NFTs.

19. The method of claim 17 wherein the data:
includes:
a selection of an algorithm;
an indication of which previous transactions of a plurality of previous transactions to utilize in generating the NFTs;
an indication of a location, within the QR code, of the plurality of placeholders; and
is used to generate the algorithmic code.

20. The method of claim 17 wherein the NFTs are generated based on one or more previous transactions involving a legacy complete QR code, the legacy complete QR code being based in part on at least a portion of the inactive QR code.
